(19) United States
(12) Patent Application Publication
(10) Pub. No.: US 2004/0020864 A1
(43) Pub. Date: Feb. 5, 2004

(54) Process for the debromination of an aqueous salt solution using ozone

(76) Inventors: Andreas Klingenberg, Seelze (DE); Manfred Klass, Stade (DE)

Correspondence Address: KEIL & WEINKAUF, 1350 CONNECTICUT AVENUE, N.W., WASHINGTON, DC, 20036, US

(21) Appl. No.: 10/332,580

(22) PCT Filed: Jul. 12, 2001
(86) PCT No.: PCT/EP01/08063

(30) Foreign Application Priority Data
Jul. 12, 2000 (DE) 100 33 762.7

(51) Int. Cl. C02F 1/78

(52) U.S. Cl. 210/760

(57) ABSTRACT

Process for the debromination of a concentrated aqueous alkali metal chloride and/or earth alkal metal chloride solution containing one or more bromide impurities, in which the solution is contacted with ozone and bromine thus formed, as well as excess ozone, is removed from the aqueous solution.

The present invention relates to a process for the debromination of a salt solution containing impurities of bromide by the use of ozone.

In many areas of application, as e.g. chemistry or pharmacy, the maximum bromide content of the chemical compounds employed is problematic. The maintenance of upper limits concerning the bromide concentration is inter alia important in the field of pharmaceutical industry.

If bromide-containing chemicals are used in the pharmaceutical area, the purity requirements of the relevant pharmacopoeiae (Pharma Euro III, p. 1234-1235) are taken as a basis. Compounds which are important in the present context are, for example, alkali and earth alkali compounds.

In particular, in alkali and earth alkali compounds which are of natural origin, the bromide content present therein embodies an important problem, because numerous anions of e.g. alkali and earth alkali salts are present in the company of bromide. The latter, for example, holds true for naturally-occurring alkali and earth alkali chlorides.

The European Pharmaceutical Codex since Jan. 1, 1997, requires for magnesium chloride, for example, a concentration limit concerning the bromide content of 500 ppm.

A process for the reduction of the bromide content by means of which the above-mentioned all-over bromide content of a compound can be achieved, is, for example, embodied by the introduction of gaseous chlorine into a solution of the particular compound present in a suitable solvent, as for example water.

The publication DE-A 21 18 623 discloses a process for the purification of aqueous magnesium chloride solutions in which the bromide content is reduced by introducing chlorine gas into these solutions.

In the publication DE-A 26 13 288 a process for the manufacture of highly concentrated magnesium chloride solutions is described. The debromination described in the latter document is accomplished by means of gaseous chlorine in the presence of heat.

The handling of gaseous chlorine, however, embodies a high potential of danger because of the reactivity of the latter gas. Accordingly, for practicing the particular processes or, respectively, experimental setups, in general for safety reasons a highly sophisticated choice of apparatuses and, therefore, also a substantial financial effort is required.

The document PCT/EP99/045 15 describes a method for the bromide depletion of an aqueous solution by using hydrogen peroxide which accomplishes the reduction of the number of required process steps.

However, the latter process requires a substantial acidification of the solution, which on the one hand enhances the corrosive properties of the solution, and on the other hands renders the reduction of the excess acid in order to maintain a pre-determined pH value necessary thereby diminishing the economical feasibility of the process by adding the above-mentioned additional process step.

Therefore, it was an objective of the present invention to provide a technical process which can be conducted using simply apparatuses, in which solutions can be depleted of bromide without having to dilute or acidify the solution.

This objective is solved by the use of ozone as means of oxidation for bromide.

Accordingly, the present invention relates to a process for the debromination of a concentrated aqueous alkali metal chloride and/or earth alkali metal chloride solution containing impurities of bromide, in which the solution is contacted with ozone and the bromine thus formed, as well as excess ozone, are separated from the aqueous solution.

In particular, the present invention relates to a process characterized in that concentrated aqueous solution contains the alkali metal and/or earth alkali metal chloride in an amount of preferred >15 wt.-%, more preferred >30 wt.-%, even more preferred >50 wt.-%, most preferred >65 wt.-%, with crystalline chloride salt taken as a basis for the calculation.

Preferred the alkali metal and/or earth alkali metal chloride content as used in the process according to the invention is >25 wt.-%, more preferred >30 wt.-%, even more preferred >50 wt.-% and particularly >65 wt.-%, respectively calculated as crystalline chloride salt.

Among the most important compounds, the solutions of which are treated by the process according to the invention in order to achieve debromination, are concentrated aqueous magnesium chloride (MgCl₂-6-H₂O) solutions which serve as basic solutions for the crystallization of MgCl₂-6-H₂O according to Ph. Eur. 3^{rd}, which allows for a bromine content in the crystalline body which amounts to a maximum of 500 ppm.

Accordingly, the present invention also relates to a process characterized in that the concentrated aqueous solution is a concentrated aqueous magnesium chloride solution.

The content of one or more bromide impurity/impurities in the concentrated aqueous magnesium chloride solution lies in the range of >100 ppm, more preferred in the range of >1.000 ppm, and most preferred in the range of 1.000 to 4.000 ppm, in relation to solid MgCl₂-6-H₂O.

Such solutions are obtained as highly concentrated magnesium chloride nobel brines containing bromide impurities from the processing of carnallitic kali raw salts, with bromine being in part found in the crystalline body upon crystallization, rendering the latter of restricted usefulness for the manufacture of MgCl₂-6-H₂O.

Therefore, the present invention also relates to a process which is characterized in that the concentrated aqueous solution is a concentrated aqueous solution of MgCl₂-6-H₂O having a content of one or more bromide impurity/impurities derived from the processing of carnallitic kali raw salts.

The ozone is produced from oxygen in situ using an ozone generating device with the oxygen or air enriched in oxygen being passed through the concentrated aqueous solution in a mixture with ozone.

In general, it is not critical in the process according to the invention, in which concentration ozone is employed for the oxidation of bromide to bromine. According to the invention, the concentration of ozone in the gaseous oxygen or in the air enriched in gaseous oxygen lies in the range of 1 to 25 vol.-%, preferred in the range of 5 to 15 vol.-%. The admission of oxygen or air enriched in oxygen to the solution amounts to 103 l/h or 51.6 l/h, respectively, for a laboratory scale setup, with an industrial scale setup being possibly designed for e.g. 1 Nm³/h.

The mass ratio of absorbed ozone to oxidized bromide desirably lies in the range of about 0.2 to 0.6:1, which corresponds to a molar ratio of about 0.3 to 0.75:1.

In the concentration range examined, the process does not exhibit any pH dependency; the reaction kinetics do not show any acid catalysis. The pH value of the starting solution in the process according to the invention generally lies in the range of 6±1, which corresponds to a pH value of 8 to 9 at a dilution of 1 to 10.

Using the process according to the invention, after the removal of elementary bromine, magnesium chloride is obtained which has a bromide content being 15<500 ppm, preferred <250 ppm, in relation to crystalline magnesium chloride. Upon longer lasting turnover of the alkali metal and/or earth alkali metal solution containing impurities of bromide with ozone and the removal of elementary bromine, magnesium chloride is obtained in which bromide is not detectable any more.

The temperature at which the process according to the invention is carried out lies usually in the range of about 0° C. to 80° C., preferred in the range of 25±10° C.

A further advantage of the process according to the invention is embodied by the fact that bromate eventually formed may undergo comproportionation with bromide to bromine which is removed according to the invention.

The bromine formed by oxidation during the course of the process may be removed from the solution according to all processes known in the state of the art. In particular, the bromine formed during the debromination process by oxidation using ozone is expelled together with excess ozone using the stream of oxygen gas or the air enriched in oxygen gas. The volume stream is highly dependent on the scale of the plant. Oxygen or air enriched in oxygen is blown into the solution with a turnover of generally 10 to 200 l/h, preferred 50 to 150 l/h (laboratory experiment); 0.1 to 10 m³/h, preferred 1 to 5 m³/h (6.000 l reactor); and 1 to 50 m³/h, preferred 5 to 20 m³/h (40.000 l reactor). The bromine expelled by the exhaust gas is washed out in an exhaust gas washing device, which, for example, may be run using a thiosulfate solution.

Furthermore, the present invention in its most general embodiment relates to the use of ozone in a process for the debromination of a concentrated aqueous alkali metal and/or earth alkali metal chloride solution containing impurities of bromide, in particular magnesium chloride solution, in which the solution is contacted with ozone and bromine thus formed as well as excess ozone, is removed from the aqueous solution.

Further, the present invention relates to the use of magnesium chloride having a bromide content of <250 ppm, in relation to crystalline magnesium chloride, which is manufactured according to the process according to the invention by subsequent crystallization of the magnesium chloride solution, to be used for medical purposes. The highly pure magnesium chloride is preferred employed for the manufacture of hemodialysis, hemofiltration or peritoneal dialysis solutions and for parenteral applications, in particular for infusion solutions. Thus, the present invention also relates to the use of magnesium chloride as specified above for the production of pharmaceuticals, particularly for the production of an aqueous solution for dialysis purposes.

The present invention will be explained hereinafter by means of worked examples.

### EXAMPLES

In a technical process, 14 l of a MgCl₂ brine, the percentage of which, calculated as MgCl₂-6-H₂O, was between 72.8% and 73.7% and which contained 1.200 to 1.300 ppm bromide (in relation to the solid), were added to a batch reactor equipped with a stirrer using radial addition of ozone gas in a gas stream of 103 l/h (ozone concentration amounting to about 13%) or of 51.6 l/h (ozone concentration amounting to about 14.5%). The pH value of the starting solution was in the range of 5 to 6, which corresponded to a pH value of 8 to 10 at a dilution of 1 to 10. The pH value of the solution was recorded on-line. The remaining bromide content of the solution was determined in time intervals of 5 or 15 minutes, respectively, as well as the ozone content in the feed gas stream and the off gas stream. Furthermore, the bromate content of the debrominated solution was determined by ion chromatography.

It was observed that the solution was turning yellowish already after 5 minutes of ozone addition. The yellow color turned more intense after 30 minutes of ozone addition and from that point on remained constant.

From the table provided hereinbelow, the values for the remaining bromide content of the starting solutions obtained by modifying the reaction conditions can be seen. In all three experiments, the bromide content after 25 or 35 minutes of reaction time, respectively, was at <500 ppm or, respectively, bromide was not any more detectable in the starting solution after 45 minutes or 55 minutes, respectively, of reaction time.

| Parameter | Example 1 | Example 2 | Example 3 |
|---|---|---|---|
| free acid (HCl) | 0.005% | — | — |
| calculated as solid content | | | |
| free alkali (NaOH) | — | 0.008% | 0.008% |
| calculated as solid content | | | |
| amount of gas/ | 1031/h | 1031/h | 51.61/h |
| ozone content | 13% | 13% | 14.5% |
| bromide content of the start- | 0.13% | 0.13% | 0.13% |
| ing solution | | | |
| (calculated as solid content in | | | |
| relation to MgCl₂-6-H₂O) | | | |
| reaction time | 25 min. | 25 min. | 35 min. |
| (bromide < 500 ppm) | | | |
| reaction time | 45 min. | 55 min. | 45 min. |
| (bromide not detectable) | | | |
| absorption efficiency | 48% | 45% | 60% |
| fraction | 0.4:1 | 0.45:1 | 0.27:1 |
| ozone:bromide | | | |
| (mass) | | | |
| fraction | 0.6:1 | 0.76:1 | 0.45:1 |
| ozone:bromide | | | |
| (moles) | | | |

1. Process for the debromination of a concentrated aqueous alkali metal chloride and/or earth alkali metal chloride solution containing impurities of bromide, wherein the solution is contacted with ozone and bromine thus formed as well as excess ozone is removed from the aqueous solution.

2. Process according to claim 1, in which the concentrated aqueous solution contains the alkali metal and/or earth alkali metal chloride in an amount of >15 wt.-%, calculated as crystalline chloride salt.

3. Process according to claim 2, in which the alkali metal and/or earth alkali metal chloride content is >25 wt.-%, calculated as crystalline chloride salt.

4. Process according to claim 3, in which the alkali metal and/or earth alkali metal chloride content is >30 wt.-%, calculated as crystalline chloride salt.

5. Process according to one or several of claims 1 to 4, in which the concentrated aqueous solution is a concentrated aqueous magnesium chloride solution.

6. Process according to claim 5, in which the concentrated aqueous solution is a concentrated aqueous magnesium chloride solution, wherein the amount of one or more bromide impurity/impurities is in the range of >100 ppm, in relation to solid MgCl₂-6-H₂O.

7. Process according to claim 6, in which the concentrated aqueous solution is a concentrated aqueous magnesium chloride solution, wherein the amount of the one or more bromide impurity/impurities is in the range of >1.000 ppm, in relation to solid MgCl₂-6-H₂O.

8. Process according to claim 7, in which the concentrated aqueous solution is a concentrated aqueous magnesium chloride solution, wherein the amount of one or more bromide impurity/impurities is in the range of 1.000 to 4.000 ppm, in relation to solid MgCl₂-6-H₂O.

9. Process according to one or several of claims 1 to 8, in which the concentrated aqueous solution is a concentrated aqueous solution of MgCl₂-6-H₂O having a content concerning one or more bromide impurity/impurities de-rived from the processing of carnallitic kali raw salts.

10. Process according to one or several of claims 1 to 9, in which ozone is generated in situ from oxygen.

11. Process according to claim 10, in which ozone, which is in situ generated in the mixture with oxygen is passed through the concentrated aqueous solution in the form of oxygen gas or air enriched in oxygen gas.

12. Process according to claim 11, in which the concentration of ozone in the oxygen gas or in the air enriched in oxygen gas is in the range of 1 to 25 vol.-%, preferred in the range of 5 to 15 vol.-%.

13. Process according to one or several of claims 1 to 12, in which the pH value is in the range of 6±1.

14. Process according to one or several of claims 1 to 13, in which magnesium chloride is manufactured having a Br⁻-content of <500 ppm, in relation to crystalline MgCl₂-6-H₂O.

15. Process according to claim 14, in which magnesium chloride is manufactured having a Br⁻-content of <250 ppm, in relation to crystalline MgCl₂-6-H₂O.

16. Process according to one or several of claims 1 to 15, which is conducted at a temperature of 0° C. to 80° C., preferred 25±10° C.

17. Process according to one or several of claims 1 to 16, in which the bromine formed by the oxidation of bromide using ozone is expelled from the concentrated aqueous solution together with excess ozone in the oxygen stream or air/oxygen stream, respectively, and optionally is washed out in a gas washer.

18. Use of ozone for the debromination of a concentrated aqueous alkali metal chloride and/or earth alkali metal chloride solution, in particular magnesium chloride solution, containing one or more bromide impurities being used in the manufacture of pharmaceuticals.

19. Use of magnesium chloride having a Br⁻-content of <250 ppm, in relation to crystalline MgCl₂-6-H₂O, obtainable by a process in which a concentrated aqueous alkali metal and/or earth alkali metal solution containing one or more impurities of bromide is contacted with ozone, and bromine thus formed and excess ozone is separated from the aqueous solution, and subsequent crystallization of the magnesium chloride for medical purposes takes place.

20. Use of magnesium chloride having a Br-content of <250 ppm, in relation to crystalline MgCl₂-6-H₂O for the production of pharmaceuticals.

21. Use of magnesium chloride having a Br⁻-content of <250 ppm, in relation to crystalline MgCl₂-6-H₂O for the production of an aqueous solution for dialysis purposes.
